(19) United States
(12) Patent Application Publication
(10) Pub. No.: US 2006/0245694 A1
(43) Pub. Date: Nov. 2, 2006

(54) Multifiber MT-type connector and ferrule comprising v-groove lens array and method of manufacture

(76) Inventors: Wenzong Chen, Naperville, IL (US); Malcolm H. Hodge, Chicago, IL (US); Ilya Makhlin, Wheeling, IL (US); Dean Richardson, Wilmette, IL (US)

Correspondence Address: MOLEX INCORPORATED, 2222 WELLINGTON COURT, LISLE, IL, 60532, US

(21) Appl. No.: 11/397,191

(22) Filed: Apr. 4, 2006

Related U.S. Application Data
(60) Provisional application No. 60/667,976, filed on Apr. 4, 2005.

(51) Int. Cl. G02B 6/38

(52) U.S. Cl. 385/71

(57) ABSTRACT

A fiber optic ferrule, preferably an MT-type ferrule, and connector design is provided that includes a unitary v-groove lens array (v-lens). The v-lens comprises a plurality of lenses and corresponding plurality of open v-grooves to align optical fibers with the plurality of lenses. Because the v-groove lens array is a unitary structure, high precision manufacturing is required for only the v-groove lens array, and not for other components forming the ferrule. A housing holds the v-groove lens array and preferably comprises a cantilever configured to retain the optical fibers substantially within their corresponding v-grooves. An opening in the housing allows an adhesive to be placed in contact with the housing, optical fibers and v-groove lens array thereby retaining the various components in a fixed relationship. A fiber optic connector may include the fiber optic ferrule in accordance with the present invention disposed within a suitable connector housing.

### PRIORITY CLAIM

This application claims priority of prior U.S. Provisional Patent Application No. 60/667,976, filed Apr. 4, 2005.

### FIELD OF THE INVENTION

The present invention relates generally to fiber optic ferrules and, more particularly, to a ferrule having a unitary v-groove lens array.

### BACKGROUND OF THE INVENTION

Fiber optic connector systems typically include mating ferrules held by their respective housings. The ferrules retain fibers in a fixed position within a fiber passageway. An end face of the fibers is finished to be flush with or slightly protruding from an end face of the ferrule. The fibers held by the ferrule, particularly the fiber end faces, are polished with a mirror finish. When complementary ferrules are adjoined, typically in an abutting relationship, two polished fibers mate in coaxial alignment to effect an interconnection. Any irregularities, burrs or scratches in a fiber finish are problematic. Such defects may disperse or reflect light at the interconnection, which adversely affects light transmission.

A central portion or core of the fiber actually carries the optically encoded information. The fiber core in the mating ferrule receives the information traveling along the fiber optic core held in the ferrule, which may accommodate more than one fiber. Perfect concentricity of the fiber cores permits maximum light transmission over the interconnection. Eccentricity of mating fiber cores increases insertion loss. A condition of gross misalignment can prevent transmission altogether. It is, therefore, important that the fiber core mate in coaxial alignment.

Furthermore, such fiber optic connectors require mutual alignment of respective fiber cores in a repeatable, separable interconnect. That is, the connector must maintain performance characteristics over multiple matings and unmatings under various environmental conditions. A separable fiber optic connector introduces a possibility that dust or other contaminants may accumulate on the end face of a fiber core that may disperse and/or attenuate the light beam. There is need, therefore, for an environmentally robust fiber optic connector that is more resistant to fiber core misalignment, and less sensitive to contaminants such as dirt and dust.

An expanded beam connector for a single as well as multiple termination (MT) connectors is known in the art. The concept utilized by both is to have a discrete lens mounted adjacent an end face of a first fiber. The lens receives the light from the first fiber and expands the beam to a relatively large diameter. The second fiber for receiving the light beam is similarly configured, having a lens positioned in front of the end face of the second fiber for receiving the expanded beam and refocuses the beam to the end face of the second fiber. Such a system does not require point-to-point contact and consequently is less susceptible to environmental conditions, such as dust, dirt and temperature variations, and also because of the expanded, larger diameter beam is more tolerant of eccentricity problems. However, such lensed systems are relatively expensive to manufacture, requiring a number of high-precision components to be assembled together, e.g., an MT ferrule requiring typical end face polishing and an array of lenses attached thereto. Therefore, it would be advantageous to provide a lensed fiber optic ferrule that is relatively low cost and easy to assemble.

### SUMMARY OF THE INVENTION

Briefly, the present invention provides an MT fiber optic ferrule and connector design that includes a unitary v-groove lens array comprising a plurality of lenses and a corresponding plurality of open v-grooves to align optical fibers with the plurality of lenses. Each v-groove comprises a fiber terminus near the focal point of its corresponding lens. Because the v-groove lens array is a unitary structure, high precision manufacturing is required for only the v-groove lens array, and not for other components forming the ferrule. The other components may comprise a boot configured to mate a fiber ribbon with a housing that, in turn, holds the v-groove lens array and preferably comprises a cantilever configured to retain the optical fibers substantially within their corresponding v-grooves. Additionally, the housing may comprise an opening, preferably disposed within the cantilever that allows an adhesive to be placed in contact with the housing, optical fibers and v-groove lens array thereby retaining the various components in a fixed relationship. The lenses within the v-groove lens array may comprise collimating or focusing lenses, and both the housing and array may include a visible indicator corresponding to the type of lenses. Furthermore, the lenses are preferably recessed within a mating surface of the v-groove lens array to create a finite and fixed mutual separation when mated. A fiber optic connector may include the fiber optic ferrule in accordance with the present invention disposed within a suitable connector housing.

A fiber optic ferrule in accordance with the present invention is fabricated by first inserting a cleaved ribbon fiber array through channels in the boot and housing so that the optical fibers reside within the v-grooves and the fiber ends reside at a corresponding terminus of each v-groove. Preferably, an index matching gel or index matching adhesive is provided in substantial proximity to the termini. Thereafter, the v-groove lens array is placed within the housing and the boot is likewise mated with the housing. Preferably, the boot comprises a stepped outer wall such that insertion of the boot is limited. Thereafter, adhesive is placed within the housing through the window and allowed to cure, thereby retaining the components of the fiber optic ferrule in a fixed relationship to one another. In this manner, the present invention satisfies the need for a robust fiber optic ferrule and connector that provides the benefits of lensed MT ferrules at reduced cost and complexity.

### BRIEF DESCRIPTION OF THE DRAWINGS

The features of the present invention are set forth with particularity in the appended claims. The present invention itself, together with further features and attendant advantages, will become apparent from consideration of the following detailed description, taken in conjunction with the accompanying drawings. One or more embodiments of the invention are now described, by way of example only, with reference to the accompanying drawings in which:

FIG. 1 is an exploded front perspective view of a lensed MT ferrule in accordance with the present invention;

FIG. 2 is an exploded rear perspective view of a lensed MT ferrule in accordance with the present invention;

FIG. 3 is a front perspective view of a partially assembled lensed MT ferrule in accordance with the present invention;

FIG. 4 is a front perspective view of a fully assembled lensed MT ferrule in accordance with the present invention;

FIG. 5 is a cross sectional view of the fully assembled lensed MT ferrule of FIG. 4; and

FIG. 6 is a flow chart illustrating a process for manufacturing a fiber optic ferrule in accordance with a presently preferred embodiment of the present invention.

### DETAILED DESCRIPTION OF THE PRESENT EMBODIMENTS

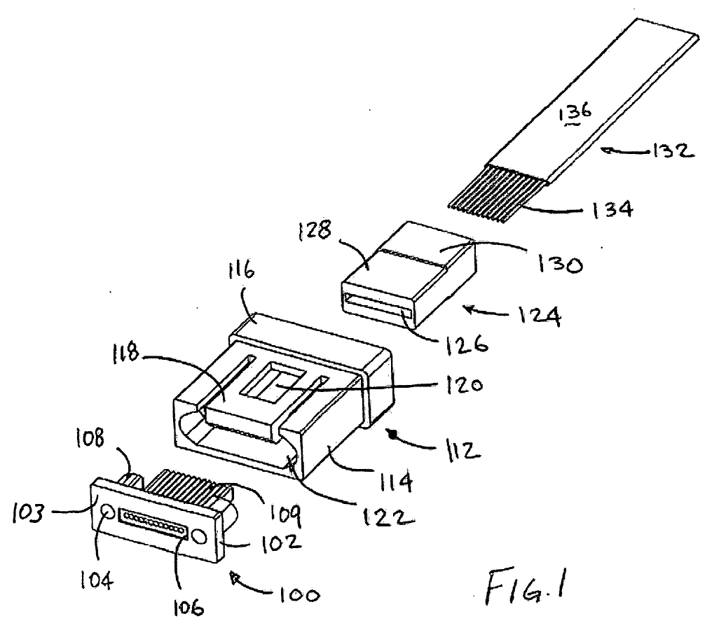

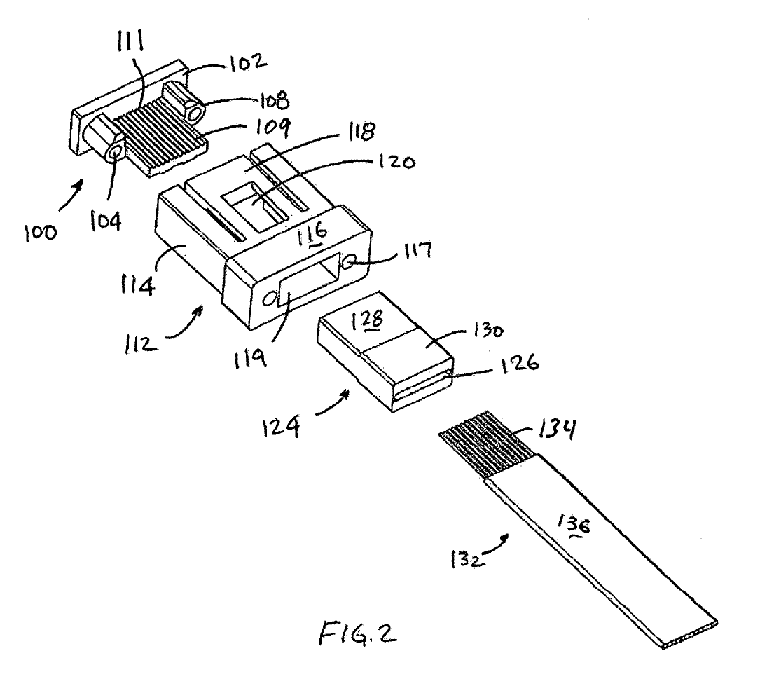

FIGS. 1 and 2 illustrate a lensed MT ferrule in accordance with the present invention. As shown, the ferrule includes a v-groove lens array (“V-lens”) 100, a housing 112, a boot 124 and a fiber optic ribbon cable 132. The V-lens 100 includes a front frame 102 having a mating surface 103. The V-lens 100 is fabricated from an optical grade plastic with a refractive index similar to that of the optical fiber, such as polycarbonate or Ultem. A plurality of lenses 106 are fabricated within the front frame 102 and, preferably, to prevent scratches to the lenses 106 during mating of the ferrule with a corresponding connector or ferrule, slightly recessed within the front frame 102 and below the mating surface 103. In alternate embodiments of the present invention, the lenses 106 may comprise collimating lenses, for those instances where the ferrule is to be mated with a complementary ferrule, or focusing lenses, for those instances where the ferrule is to be mated with an active device, i.e., a light source or receiver.

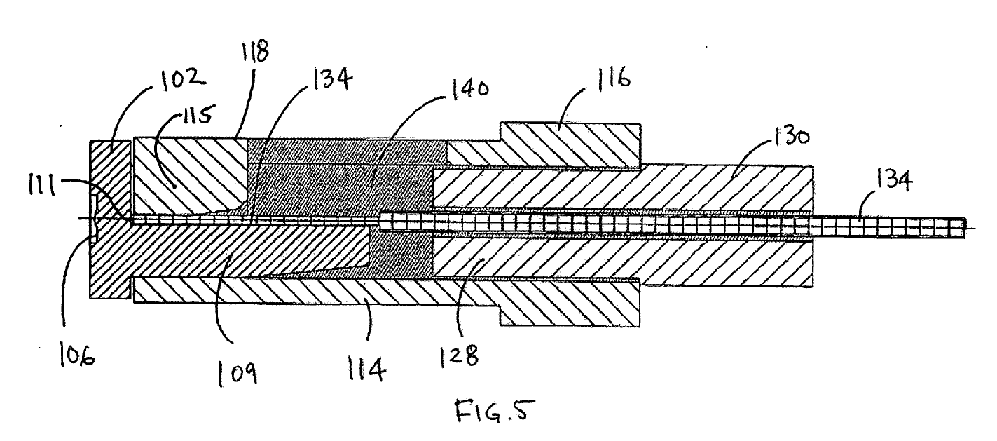

A pair of pin passageways 108 having pin apertures 104 is provided in the V-lens 100 for receiving alignment pins (not shown). A number of v-grooves 109 (that is, grooves each having a v-shaped cross-sectional profile) for receiving optical fibers 134 are formed integral to the V-lens 100. In a presently preferred embodiment, and as best illustrated in FIG. 5, each v-groove comprises a terminus 111 near the focal point of a corresponding lens 106. Although v-grooves are illustrated in the accompanying Figures and described herein, it is understood that grooves having different cross-sectional profiles, e.g., semi-circular grooves or rectangular grooves, may be equally employed. Regardless, a particular advantage of the present MT ferrule is that only the V-lens 100 portion of the ferrule requires precision machining and tooling. This helps to keep costs much lower than if the V-Lens 100 and the housing 112 were made as one piece, or if the v-grooves 109 were formed integral to the housing 112, for example.

The housing 112, which may be preferably fabricated from glass filled thermo plastics such as liquid crystal polymer, preferably comprises walls 114, a collar 116 disposed adjacent a rear portion of the housing 112 and a cantilever 118 preferably having an inward-facing protrusion 115 (FIG. 5). Furthermore, a front opening 122 for receiving the V-lens 100 and a rear opening 119 for receiving the boot 124 are also provided, the front opening 122 and rear opening 119 defining ends of a longitudinal channel formed through the housing 112. Pin apertures 117 are also provided for receiving alignment pins (not shown). The cantilever 118 is configured, given the dimensions of that portion of the V-lens 100 comprising the v-grooves 109, to substantially retain the optical fibers 134 aligned with and within corresponding v-grooves 109. In the preferred embodiment illustrated, the protrusion 115 engages the fibers 134 through the biasing force provided by the cantilever 118.

According to one aspect of the present invention, the housing 112 comprises an opening or window formed therein and providing access to the channel formed within the housing 112. Although the opening can be formed in any wall 114 of the housing 112, in a presently preferred embodiment, an opening or window 120 is formed in the cantilever 118. Furthermore, in an alternative embodiment, the cantilever 118 can be replaced by a separate hold down plate, placed within an opening formed in the housing 112, of similar dimensions to the cantilever head 115 and including the opening 120, thereby providing greater control over the forces applied by the hold down plate on the optical fibers 134. The area of the window 120 and of the two beams would be open for ease of visually monitoring fiber placement and adhesive application during assembly. In one aspect of the present invention, the housing 112 or V-lens 100 may comprise a visual indication of the types of lenses 106 (e.g., collimating or focusing) included in the V-lens 100. For example, the housing 112 or a portion of V-lens 100 may be colored differently depending on the type of lenses 106 included, although a variety of equally suitable alternatives will be readily apparent to those having skill in the art.

The boot 124, which may be fabricated from thermo plastic rubber such as polypropylene vulcanization elastomer, includes a front insertion portion 128 for inserting into the rear opening 119 and a raised or stepped stop portion 130, defined by an outer wall of the boot 124, for limiting the depth of the insertion through engagement with the collar 116. Those having skill in the art will appreciate that other mechanisms for limiting insertion of the boot 124 within the housing 112 may be equally employed. A slot or channel 126 is provided within the boot 124 for receiving the fiber optic ribbon cable 132. The slot is dimensioned to preferably provide a slight interference fit with the cable jacket. Nevertheless, there is enough clearance for the adhesive to penetrate the boot interior. The cable 132 includes multiple optical fibers 134 and a buffer 136. In a presently preferred embodiment, the cable 132 comprises twelve optical fibers 134 and the V-lens 100 comprises a corresponding number of v-grooves 109. However, those having skill in the art will appreciate that a greater or lesser number of fibers 134 and corresponding v-grooves 109 may be equally employed as a matter of design choice. The number of fibers is preferably equal to or less than the number of V-grooves. However, the ferrule of the present invention permits two or more fiber ribbons or individual fibers to be terminated within the same ferrule.

The fiber optic ferrule illustrated in FIGS. 1-5 may be incorporated into a fiber optic connector. In this case, the ferrule of the present invention may be disposed within a connector housing configured to receive and retain the ferrule in a substantially fixed relationship, thereby providing a mechanism, for example, for repeatedly mating and unmating the ferrule with a complementary connector and ferrule or other device. Various types of connector housings suitable for this purpose will be known to those having skill in the art, and the present invention is not limited in this regard.

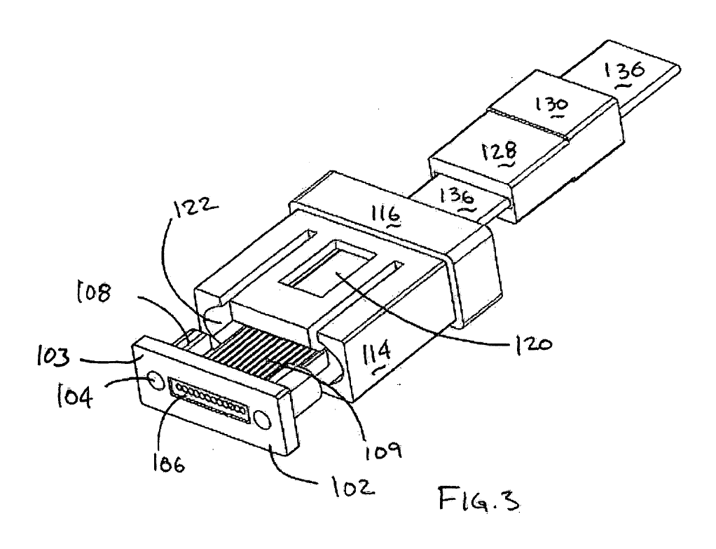

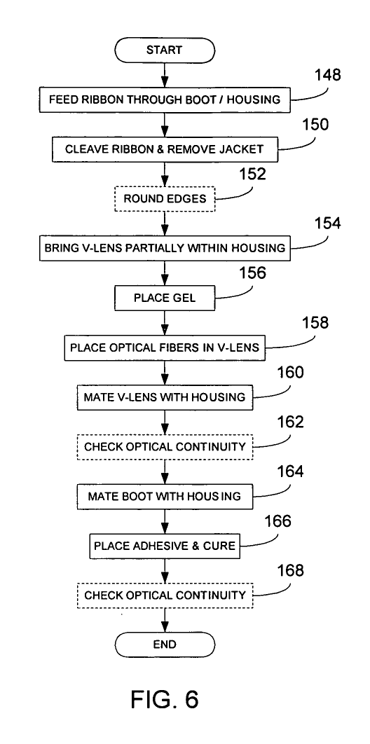

A presently preferred method for manufacturing a fiber optic ferrule in accordance with the present invention is illustrated with reference to FIG. 6 and with further reference to FIGS. 3-5. Although a variety of steps are illustrated in FIG. 6, not all steps need to be performed as described in further detail below. Thus, at block 148, the fiber optic ribbon cable 132 is threaded through the slot 126 of the boot 124 and through the channel in the housing 112. At block 150, the fiber optic ribbon cable 132 is cleaved or otherwise cut using known techniques to provide relatively uniform fiber ends on each fiber 134. In particular, it is desirable to cleave the fibers 134 along a plane that is substantially perpendicular to the longitudinal axis of the ribbon 132, thereby providing fibers 134 of substantially equivalent length. Additionally, at block 150, a portion of the jacket 136 encasing the optical fibers 134 is removed to thereby expose the individual fibers, as illustrated in FIGS. 1 and 2. Preferably, the length of jacket 136 removed from the ribbon is enough to expose lengths of optical fibers 134 that are at least as long as the length of the v-grooves 109. At block 152, the fiber ends are optionally rounded to remove any sharp edges and thereby decrease the likelihood that the fibers 134 will catch upon and skive or otherwise damage the v-grooves 109 when inserted therein. Various techniques for rounding the fiber ends, such as fire polishing or “violining”, may be used as a matter of design choice.

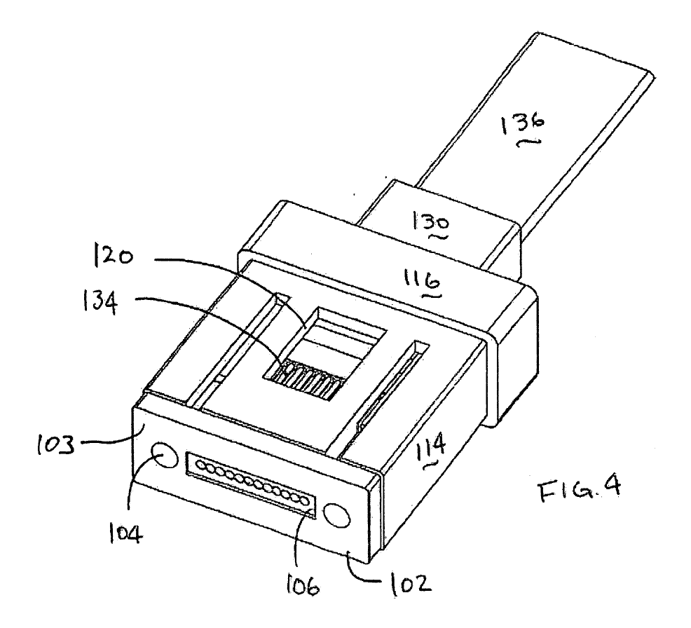

Continuing at block 154, and as further illustrated in FIG. 3, the V-lens 100 is brought partially within the housing 112 through the front opening 122. As shown, the front opening 122 is preferably shaped to accept the pin passageways 108 of the V-lens 100 such that the assembly provides a snug secure fit. Once partially disposed within the housing 112, index matching gel or index matching adhesive, as known in the art, is placed within the v-grooves 109 at block 156, preferably at least within or in substantial proximity to the termini 111 of the v-grooves 109. Thereafter, at block 158, the optical fibers 134 are placed or positioned within corresponding v-grooves 109. Preferably, the fibers 134 are placed within the v-grooves 109 so that the fiber ends contact, or are at least in very close proximity to, the termini 111 of the v-grooves 109. Thereafter, at block 160, the v-lens 100 is pushed into the housing 112, along with the ribbon cable 132, thereby allowing the v-lens 100 to fully mate with the housing 112, as illustrated in FIG. 4. As further illustrated in FIG. 4, note that the window 120 provides access to the interior of the housing 112 and that the open configuration of the v-grooves 109 permits exposure of the optical fibers 134 even when the v-lens 100 is fully mated with the housing 112.

At block 162, optical continuity of the ferrule may be optionally tested using known techniques. Although the v-lens 100 and housing 112 are dimensioned to preferably provide a snug fit with each other, they remain relatively weakly mechanically coupled at this point of the manufacturing process, thereby permitting uncoupling and recoupling of the v-lens 100 and housing 112 if necessary. For example, if continuity testing suggests that one or more of the fibers 134 is not properly seated within its corresponding v-groove, the v-lens 100 may be removed from the housing 112, thereby permitting reseating of the fibers 134.

Continuing at block 164, the boot 124 is fully mated with the housing 112, as illustrated in FIG. 4. As noted above, the stepped portion 130 of the boot 124 engages the housing 112, as best illustrated in FIG. 5, to limit insertion of the boot 124 into the housing 112. Thereafter, at block 166, an adhesive 140, which may comprise a suitable thermally cured adhesive such as TraBond F253, is placed within the housing 112 through the opening 120 and substantially surrounding the optical fibers 134. Note that the viscosity of the adhesive 140 is such that it is able to substantially fill any voids occurring between the components of the ferrule. Thus, when the adhesive 140 has fully cured, the various components of the ferrule (i.e., the v-lens 100, housing 112, optical fibers 134, cable 132 and boot 124) are maintained in a fixed position relative to each other. Thereafter, at block 168, further optical continuity testing may be optionally performed as desired.

While the particular preferred embodiments of the present invention have been shown and described, it will be obvious to those skilled in the art that changes and modifications may be made without departing from the teachings of the invention. It is therefore contemplated that the present invention cover any and all modifications, variations or equivalents that fall within the spirit and scope of the basic underlying principles disclosed above and claimed herein.

What is claimed is:

1. A fiber optic ferrule, comprising:
a v-groove lens array having a plurality of lenses and a corresponding plurality of open v-grooves for receiving optical fibers;
a housing for holding the v-groove lens array; and
a boot for holding the optical fibers for insertion into the housing.

2. The fiber optic ferrule of claim 1, wherein the plurality of lenses comprises at least one collimating lens.

3. The fiber optic ferrule of claim 1, wherein the plurality of lenses comprises at least one focusing lens.

4. The fiber optic ferrule of claim 1, wherein each of the plurality of corresponding v-grooves comprises a terminus near the focal point of a corresponding one of the plurality of lenses, and wherein fiber ends of each of the optical fibers reside at a corresponding terminus.

5. The fiber optic ferrule of claim 4, further comprising:
an index-matching medium disposed at least within the terminus of each of the plurality of corresponding v-grooves.

6. The fiber ferrule of claim 5 wherein the index-matching medium is an index-matching gel.

7. The fiber ferrule of claim 5 wherein the index-matching medium is a curable optical adhesive

8. The fiber optic ferrule of claim 1, wherein the v-groove lens array includes a frame having a recessed aperture for holding the plurality of lenses.

9. The fiber optic ferrule of claim 1, wherein the housing comprises a cantilever configured to retain the optical fibers substantially within the plurality of open v-grooves.

10. The fiber optic ferrule of claim 1, wherein the housing comprises an opening, and further comprising:
a hold down plate, disposed with the opening, configured to retain the optical fibers substantially within the plurality of open v-grooves.

11. The fiber optic ferrule of claim 9, wherein the cantilever includes a window.

12. The fiber optic ferrule of claim 1, further comprising an adhesive that is placed within the housing to retain the housing, v-groove lens array and optical fibers in a fixed relationship to one another.

13. The fiber optic ferrule of claim 1, wherein the boot includes at least one stepped outer wall for limiting insertion of the boot into the housing.

14. The fiber optic ferrule of claim 1, wherein the housing comprises a visual indicator corresponding to a type of the plurality of lenses.

15. The fiber optic ferrule of claim 1, wherein the v-groove lens array is manufactured with a precision greater than housing.

16. A fiber optic connector comprising:
a v-groove lens array having a plurality of lenses and a corresponding plurality of open v-grooves for receiving optical fibers;
a housing for holding the v-groove lens array;
a boot for holding the optical fibers for insertion into the housing; and
a connector housing having the fiber optic ferrule disposed therein.

17. A method for assembling a fiber optic ferrule, the method comprising:
providing a v-groove lens array having a plurality of lenses and a corresponding plurality of open v-grooves for receiving optical fibers;
placing the optical fibers in corresponding ones of the plurality of open v-grooves; and
mating the v-groove lens array with, and maintaining the optical fibers within, a housing.

18. The method of claim 17, further comprising:
feeding the optical fibers through a channel in a boot; and
feeding the optical fibers through a channel in the housing.

19. The method of claim 17, further comprising, prior to placing the optical fibers in the plurality of open v-grooves:
removing a portion of a jacket surrounding the optical fibers;
cleaving the optical fibers to provide cleaved ends of the optical fibers; and
smoothing the cleaved ends of the optical fibers.

20. The method of claim 17, further comprising:
placing an index-matching gel or curable optical adhesive in substantial proximity to a terminus of each of the plurality of corresponding v-grooves and ends of the optical fibers.

21. The method of claim 17, further comprising:
mating a boot with a rear opening of the housing.

22. The method of claim 17, further comprising:
placing an adhesive within the housing to retain the optical fibers within the housing.
